(19) United States
(12) Patent Application Publication
(10) Pub. No.: US 2026/0077522 A1
(43) Pub. Date: Mar. 19, 2026

(54) RAZOR CARTRIDGE

(71) Applicant: DORCO CO., LTD., Seoul (KR)

(72) Inventors: Sung Hee SON, Seoul (KR); Jun Soo CHANG, Seoul (KR); Jong Jin JEONG, Seoul (KR)

(21) Appl. No.: 19/399,238

(22) Filed: Nov. 24, 2025

Related U.S. Application Data
(63) Continuation of application No. PCT/KR2024/007021, filed on May 23, 2024.

(30) Foreign Application Priority Data
May 26, 2023 (KR) 10-2023-0068696
Jul. 21, 2023 (KR) 10-2023-0095160
May 22, 2024 (KR) 10-2024-0066771

(51) Int. Cl. B26B 21/40; B26B 21/22; B26B 21/44

(52) U.S. Cl. CPC B26B 21/4018; B26B 21/4025; B26B 21/4031; B26B 21/22; B26B 21/443

(57) ABSTRACT

A razor cartridge is proposed. The razor cartridge may include at least one blade having a cutting edge, and a blade housing accommodating the blade in a longitudinal direction. The razor cartridge may also include a guard unit disposed in front of the blade accommodated in the blade housing with respect to the shaving direction. The guard unit may include a first flexible guard, disposed adjacent to the blade, for contacting the skin of a user. The guard unit may also include a hard guard, disposed in front of the first flexible guard with respect to the shaving direction and having recesses and protrusions formed on the surface thereof, the recesses and protrusions having a three-dimensional surface roughness (SA) in the range of 20 μm-200 μm.

### CROSS REFERENCE TO RELATED APPLICATIONS

This is a continuation application of International Patent Application No. PCT/KR2024/007021 filed on May 23, 2024, which claims priority to Korean patent application No. 10-2023-0068696 filed on May 26, 2023, Korean patent application No. 10-2023-0095160 filed on Jul. 21, 2023, and Korean patent application No. 10-2024-0066771 filed on May 22, 2024, contents of each of which are incorporated herein by reference in their entireties.

### BACKGROUND

### Technical Field

The disclosure relates to a razor cartridge, and more particularly to a razor cartridge in which at least one blade is accommodated.

### Description of Related Technology

In general, a razor refers to a product for cutting body hair such as fuzz and stubble on a face or body, and includes a razor handle for a grip, and a razor cartridge with a blade that comes into contact with skin to have a shave.

### SUMMARY

One aspect is a razor cartridge with a guard including two or more different materials to have complex functions.

The aspects of the disclosure are not limited to those described herein, and other aspects not mentioned herein may become apparent to those skilled in the art from the following description.

Another aspect is a razor cartridge including: at least one blade formed with a cutting edge; a blade housing to accommodate the blade in a longitudinal direction; and a guard portion disposed in front of the blade accommodated in the blade housing with respect to a shaving direction, wherein the guard portion includes: a first flexible guard disposed adjacent to the blade to come into contact with skin of a user; and a rigid guard disposed in front of the first flexible guard with respect to the shaving direction, and formed with unevenness having a three-dimensional surface roughness (SA) of 20 μm to 200 μm on a surface thereof.

Other details of the disclosure are included in the detailed description and the accompanying drawings.

According to the embodiments of the disclosure, the effects are at least as follows.

Excessive friction is prevented between a guard portion and skin, so that a razor cartridge can glide more smoothly on the skin.

Foreign substances are more effectively removed on skin before shaving.

A shaving aid is retained in an unevenness of a rigid guard, thereby allowing the razor cartridge to glide more smoothly.

The effects of the disclosure are not limited to those described above, and various other effects are included in the foregoing description.

### BRIEF DESCRIPTION OF THE DRAWINGS

FIG. 1 is a perspective view showing a razor cartridge according to an embodiment of the disclosure.

FIG. 2 is a cross-sectional view taken along line AA in FIG. 1.

FIG. 3 is a graph showing a longitudinal surface profile of a rigid guard.

FIG. 4 is a view to illustrate a shape of a guard portion with respect to a shaving plane of a razor cartridge according to an embodiment of the disclosure.

FIG. 5 is an enlarged cross-sectional view of a guard portion of a razor cartridge according to an embodiment of the disclosure.

FIG. 6 is an enlarged cross-sectional view of a rigid guard and a second flexible guard of a razor cartridge according to an embodiment of the disclosure.

### DETAILED DESCRIPTION

A razor cartridge typically includes a guard that comes into contact with skin before the blade.

The guard comes into contact with the skin before the blade to pull the skin and improve shaving effects, and forms a shaving plane to prevent the blade from entering the skin too deeply.

The guard is generally made of a material having high friction (e.g., rubber, silicone, etc.) to improve close contact with the skin. However, excessive friction between the guard and the skin deteriorates gliding performance of the razor cartridge on a skin surface, and causes a user to experience discomfort during shaving stroke.

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, first, second, i), ii), a), b) and the like terms may be used in describing elements according to embodiments of the disclosure. Such terms are used solely for the purpose of differentiating one element from another, but not limit the substances, the order, sequence, etc. of those elements. Throughout this specification, when a part ‘includes’ or ‘comprises’ an element, the part is meant to further include other elements rather than excluding other elements unless otherwise stated explicitly.

Below, a razor cartridge according to an embodiment of the disclosure will be described with reference to the accompanying drawings.

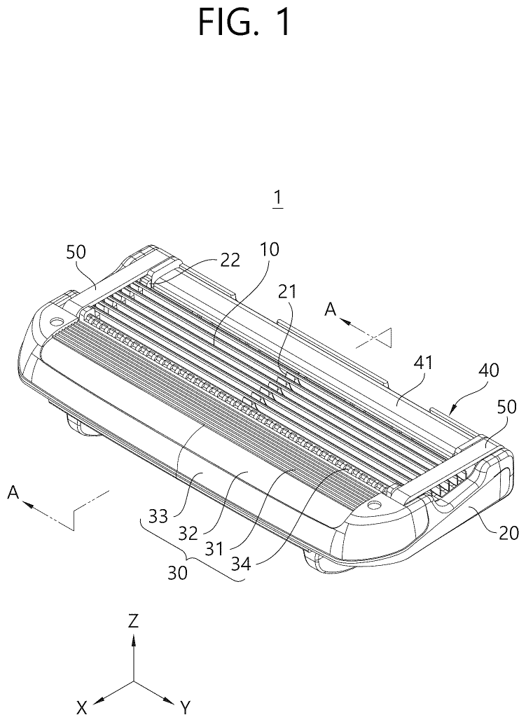

FIG. 1 is a perspective view showing a razor cartridge according to an embodiment of the disclosure.

Referring to FIG. 1, a razor cartridge 1 according to an embodiment of the disclosure includes at least one blade 10 and a blade housing 20.

The top surface of the blade housing 20 (to be described later) refers to a surface that comes into contact with a user's skin or faces a user's skin during a shaving process. The upper direction of the blade housing 20 refers to a direction (positive Z-axial direction) in which the top surface faces. The bottom surface of the blade housing 20 refers to an opposite surface to the top surface. The lower direction of the blade housing 20 refers to a direction (negative Z-axial direction), in which the bottom surface faces, i.e., an opposite direction to the upper direction. The front direction of the blade housing 20 refers to a direction (shaving direction, i.e., positive X-axial direction) in which the blade housing 20 advances relative to a user's skin during the shaving process, and the back direction of the blade housing 20 refers to an opposite direction (negative X-axial direction) to the front direction.

The blade housing 20 is formed with an accommodating space in which a plurality of blades 10 are accommodated in a longitudinal direction (Y-axial direction). The accommodating space may be formed penetrating the blade housing 20 up and down so that shaving residues introduced between the plurality of blades 10 can be easily discharged. FIG. 1 shows an example that the razor cartridge 1 includes six blades 10, but the number of blades 10 may vary depending on embodiments.

Referring to FIG. 1, the blade housing 20 may include a blade mounting portion 21, 22 to which the plurality of blades 10 are mounted. The blade mounting portion may include a first blade mounting portion 21 and a second blade mounting portion 22.

The first blade mounting portion 21 may accommodate and/or support the middle portion of the plurality of blades 10, and the second blade mounting portion 22 may accommodate and/or support both sides of the plurality of blades 10. The first blade mounting portion 21 may be formed to cross the accommodating space in a transverse direction. The second blade mounting portion 22 may be formed on the opposite sides of the accommodating space 21 in the longitudinal direction. The first blade mounting portion 21 and the second blade mounting portion 22 may be configured to elastically support the plurality of blades 10.

According to an alternative embodiment, the blade housing 20 may exclude the first blade mounting portion 21. In this case, the plurality of blades 10 may be accommodated in and/or supported by the second blade mounting portion 22 on both sides.

Referring to FIG. 1, the razor cartridge 1 may include a clip 50 at least partially positioned on both sides of the plurality of blade 10 and preventing the blade 10 from breaking away through the top surface of the blade housing 20. Both ends of the clip 50 may be coupled to the blade housing 20. According to an embodiment, the clip 50 may be replaced with a separate cover member to be coupled to the top surface of the blade housing 20.

Referring to FIG. 1, the razor cartridge 1 may include a cap portion 40 disposed at the rear of the blades 10, and the cap portion 40 may include a lubrication band 41. The lubrication band 41 may be installed so that its upper surface can be exposed to the top surface of the blade housing 20 and the cap portion 40. The lubrication band 41 may include a lubricating material to be applied to a skin surface where the blades 10 have passed during a shaving process. The lubricating material may contain ingredients to protect the skin after shaving.

Referring to FIG. 1, the razor cartridge 1 includes a guard portion 30 provided in front of the blades 10. The guard portion 30 refers to a portion that comes into contact with skin before the blades 10 during a shaving process, thereby providing functions such as pulling the skin, aligning body hair, or removing foreign substances on the skin.

The guard portion 30 may be formed integrally with the blade housing 20, or may be formed separately from and coupled to the blade housing 20. Alternatively, some components of the guard portion 30 may be formed integrally with the blade housing 20 and other components may be formed separately from and coupled to the blade housing 20.

The guard portion 30 includes a flexible guard 31, 33, and a rigid guard 32. Further, the guard portion 30 may further include a rigid guard bar 34.

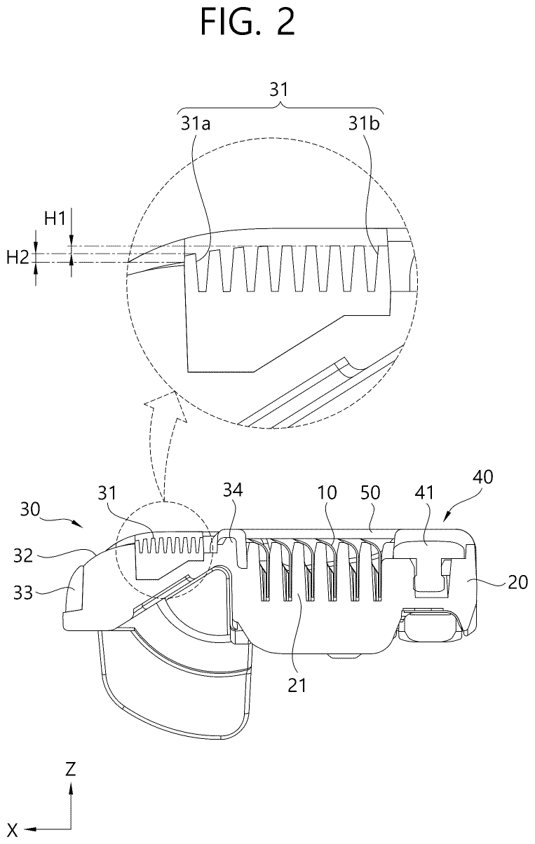

Further, details of the guard portion 30 will be described with reference to FIGS. 2 to 6 in addition to FIG. 1.

FIG. 2 is a cross-sectional view taken along line AA in FIG. 1.

Referring to FIGS. 1 and 2, the flexible guard 31, 33 may include a first flexible guard 31 and a second flexible guard 33.

The first flexible guard 31 is placed in front of the blade 10 and adjacent to the blade 10.

Referring to FIG. 2, the first flexible guard 31 may include a plurality of flexible fins 31a and 31b protruding upward. The plurality of flexible fins 31a and 31b comes into close contact with a user's skin during the shaving process and pulls the skin to improve the shaving effect of the blades 10. To this end, the plurality of flexible fins 31a and 31b may be made of a flexible material excellent in close contact with the skin, such as rubber or silicone elastomer.

Referring to FIGS. 1 and 2, the flexible fins 31a and 31b may extend along the longitudinal direction (Y-axial direction) and be arranged along the transverse direction (X-axal direction). A surface formed by connecting the tips of the flexible fins 31a and 31b may constitute the top surface of the first flexible guard 31.

A height difference H1 may be formed between the top of the frontmost flexible fin 31a of the plurality of flexible fins 31a and 31b and the top of the rearmost flexible fin 31b of the plurality of flexible fins 31a and 31b. The top of the front flexible fin 31a may be positioned lower than the top of the rear flexible fin 31b, and the height difference H1 between them may range from 0.1 mm to 1.0 mm.

The tops of the plurality of flexible fins 31a and 31b may get lower forwards. The height difference in the top between the flexible fin located relatively forward and its neighboring flexible fin may be larger than that between the flexible fin located relatively rearward and its neighboring flexible fin. In other words, the plurality of flexible fins 31a and 31b may be formed in such a manner that the height difference in the top between the flexible fin and its rearward adjacent flexible fin gets larger toward the front. However, the tops of some flexible fins, in particular, flexible fins positioned relatively rearward, may have approximately the same height.

The top surface of the first flexible guard 31 may be formed as a substantially streamlined curved surface that gets lower toward the front. Therefore, during the shaving process, the skin located in front of the first flexible guard 31 naturally comes into contact with the first flexible guard 31 when the razor cartridge 1 moves in the shaving direction (positive X-axial direction) while pressing the skin, thereby allowing the razor cartridge 1 to glide smoothly.

The second flexible guard 33 may be placed in front of the rigid guard 32 (to be described later). The second flexible guard 33 may be connected to the first flexible guard 31 on the outside of the rigid guard 32. According to an alternative embodiment, the second flexible guard 33 may be omitted, and the rigid guard 32 may extend up to the position of the second flexible guard 33.

Like the first flexible guard 31, the second flexible guard 33 may be made of a flexible material excellent in close contact with the skin, such as rubber or silicone elastomer.

In the guard portion 30, the second flexible guard 33 may first come into contact with the skin during the shaving process. While the razor cartridge 1 moves, the second flexible guard 33 is in close contact with the skin and pulls the skin so that the skin being in contact with the rigid guard 32 can be kept tight.

More detailed descriptions about the second flexible guard 33 will be made later.

The rigid guard bar 34 may be provided between the first flexible guard 31 and the blade 10.

The rigid guard bar 34 may define the shaving plane (to be described later), or align body hair before the body hair is cut by the blade 10, thereby improving the shaving effect. According to an embodiment, the rigid guard bar 34 may include concave and convex patterns spaced apart in the longitudinal direction perpendicular to the shaving direction so that the body hair can be aligned in the shaving direction.

Referring to FIGS. 1 and 2, the rigid guard 32 may be placed in front of the first flexible guard 31.

The rigid guard 32 may be made of a rigid material, of which friction with skin is lower than that of the first flexible guard 31. As shown in FIG. 2, the rigid guard 32 may be formed integrally with the blade housing 20. In this case, the rigid guard 32 may be made of the same material (e.g., plastic) as the blade housing 20.

The guard portion 30 of the razor cartridge 1 according to this embodiment includes the flexible guards 31 and 33 and the rigid guard 32. Accordingly, the area proportion of the flexible guards 31 and 33 on the top surface of the guard portion 30 is reduced to prevent excessive friction caused between the guard portion 30 and the skin during shaving, thereby making the shaving strokes more smoothly.

Because the rigid guard 32 having lower friction with skin than the first flexible guard 31 is placed in front of the first flexible guard 31, the skin comes into contact with the rigid guard 32 before the first flexible guard 31 during the shaving process, and thus the strokes of the razor cartridge 1 are made smooth.

The top surface of the rigid guard 32 may be positioned lower than the top surface of the first flexible guard 31. The top surface of the first flexible guard 31 may be defined by the tops of the plurality of flexible fins 31a and 31b.

Further, referring to FIG. 2, the rigid guard 32 and the first flexible guard 31 may have a height difference at a boundary therebetween. In other words, a height difference H2 may be formed between the rear end of the rigid guard 32 and the top of the frontmost flexible fin 31a of the plurality of flexible fins 31a and 31b. The rear end of the rigid guard 32 may be positioned lower than the top of the front flexible fin 31a, and the height difference H2 between them may range from 0.1 mm to 1.0 mm.

The first flexible guard 31, which is more flexible than the rigid guard 32, is pressed against the skin during the shaving process and is elastically deformed. Accordingly, due to the height difference H2 between the rigid guard 32 and the first flexible guard 31, the first flexible guard 31 more effectively comes into close contact with the skin and pulls the skin in the shaving direction.

According to an alternative embodiment, the rigid guard 32 and the first flexible guard 31 may have no height difference at a boundary therebetween.

Referring to FIG. 2, the top surface of the rigid guard 32 may have a substantially streamlined curved surface that becomes lower toward the front. Accordingly, a contact area between the rigid guard 32 and skin is increased compared with when the rigid guard 32 is formed flat. Further, during the shaving process, when the razor cartridge 1 moves in the shaving direction while pressing the skin, the skin located in front of the rigid guard 32 naturally comes into contact with the rigid guard 32, so the razor cartridge 1 can glide smoothly. In particular, referring to FIG. 2, the rigid guard 32 having the streamlined curved surface rather than an elastic material is provided at a corner between the front and top surface of the razor cartridge 1, thereby causing a smooth stroke of the razor cartridge 1.

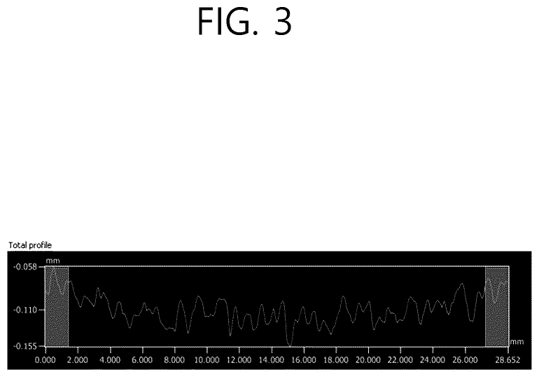

FIG. 3 is a graph showing a longitudinal surface profile of a rigid guard.

Referring to FIG. 3, unevenness having a three-dimensional surface roughness (SA) of approximately 20 μm to 200 μm may be formed on the top surface of the rigid guard 32. The unevenness may have an irregular profile and/or a regular profile.

For example, the unevenness formed on the top surface of the rigid guard 32 removes foreign substances (for example, dead skin cells, excessively applied shaving aid, etc.) present on a user's skin during the shaving process, thereby improving the shaving effect.

As the razor cartridge 1 moves in the shaving direction during the shaving process, the rigid guard 32 comes into contact with the skin before the first flexible guard 31 and removes foreign substances on the skin, and then the first flexible guard 31 comes into close contact with the skin from which the foreign substances have been removed and pulls the skin.

Further, the unevenness formed on the top surface of the rigid guard 32 retain some of the shaving aid present on a user's skin in unevenness interspaces, thereby enabling smoother strokes of the razor cartridge 1 while providing a smoother shaving feeling.

When the three-dimensional surface roughness (SA) of the unevenness formed on the top surface of the rigid guard 32 is smaller than 20 μm, the unevenness's ability to retain the shaving aid is decreased.

When the three-dimensional surface roughness (SA) of the unevenness formed on the top surface of the rigid guard 32 is greater than 200 μm, the roughness of the top surface of the rigid guard 32 makes it difficult for a user to feel a smooth shave and makes it inconvenient to wash away the shaving aid excessively retained in the unevenness.

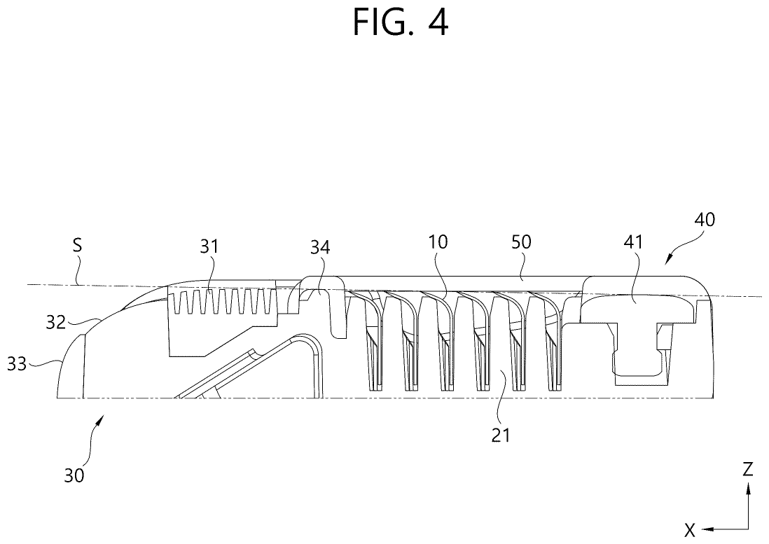

FIG. 4 is a view to illustrate a shape of a guard portion with respect to a shaving plane of a razor cartridge according to an embodiment of the disclosure.

Referring to FIG. 4, a plane connecting the topmost of the guard portion 30 and the topmost of the cap portion 40 may be defined as a shaving plane S. According to an embodiment, the shaving plane S may be defined as a plane connecting the top of the components placed in front of the blade 10 among the components of the blade housing 20, and the top of components placed in back of the blade 10 among the components of the blade housing 20.

According to an embodiment shown in FIG. 4, the top of the guard portion 30 may be the top of the rigid guard bar 34, and the top of the cap portion 40 may be the top of the lubrication band 41. In this case, the shaving plane S may be defined as a plane connecting the top of the rigid guard bar 34 and the top of the lubrication band 41.

The shaving plane refers to an imaginary plane where the razor cartridge 1 or the blade housing 20 is considered to be in contact with skin at the same time. The cutting edge of the blade 10 may be adjacent to the shaving plane, and at least some of cutting edges of blades 10 may be located below or above the shaving plane. For example, the blades located at the front of the blades 10 are arranged such that the cutting edges have a negative exposure below the shaving plane to prevent skin cuts, the blades located at the back of the blades 10 are arranged such that the cutting edges have a positive exposure above the shaving plane to have a cleaner shave, and the blades located in a center portion of the blades 10 are arranged such that the cutting edges have a zero exposure to the shaving plane.

Referring to FIG. 4, the rigid guard 32 can be placed to have a negative exposure with respect to the shaving plane S. This placement of the rigid guard 32 prevents the rigid guard 32 from affecting the shaving plane S and minimizes skin irritation due to the unevenness formed on the top surface of the rigid guard 32. At least a portion of the top surface of the rigid guard 32 may include a curved profile whose slope with the shaving plane S gradually increases forward.

Further, the second flexible guard 33 may also be placed to have a negative exposure with respect to the shaving plane S, and at least a portion of the top surface of the second flexible guard 33 may include a curved profile whose slope with the shaving plane S gradually increases forward.

At least a portion of the first flexible guard 31 may be disposed to have a positive exposure, a negative exposure, or the zero exposure with respect to the shaving plane S. In other words, the top of at least some of the plurality of flexible fins 31a and 31b of the first flexible guard 31 may be disposed to have a positive exposure, a negative exposure, or the zero exposure with respect to the shaving plane S. For example, the top of the flexible fin located relatively rearward of the plurality of flexible fins 31a and 31b of the first flexible guard 31 may be disposed to have a positive exposure or the zero exposure with respect to the shaving plane S, and the top of the flexible fin located relatively forward of the plurality of flexible fins 31a and 31b may be disposed to have a negative exposure or the zero exposure with respect to the shaving plane S. The top of the frontmost flexible fin 31a of the plurality of flexible fins 31a and 31b may be disposed to have a negative exposure with respect to the shaving plane S.

According to an embodiment, when the rigid guard bar 34 is excluded, the shaving plane S may be defined as a plane connecting the top of the rearmost flexible fin 31b of the plurality of flexible fins 31a and 31b and the top of the cap portion 40. Even in this case, at least some blades 10 may be arranged to have a negative exposure, a zero exposure or a positive exposure with respect to the shaving plane S similarly to those described above, and the top surface of the rigid guard 32 may be disposed to have a negative exposure with respect to the shaving plane S.

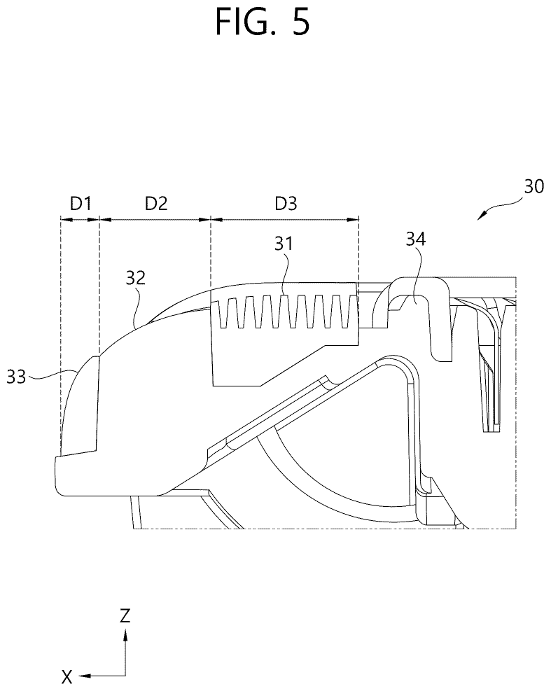

FIG. 5 is an enlarged cross-sectional view of a guard portion of a razor cartridge according to an embodiment of the disclosure.

Referring to FIG. 5, a transverse width D1 of the second flexible guard 33, a transverse width D2 of the rigid guard 32, and a transverse width D3 of the first flexible guard 31 are shown.

The transverse width D1 of the second flexible guard 33 may be formed to be shorter than the transverse width D2 of the rigid guard 32 and the transverse width D3 of the first flexible guard 31.

The transverse width D3 of the first flexible guard 31 may be formed to be longer than the transverse width D2 of the rigid guard 32. In this case, the razor cartridge 1 may tightly pull skin to shave by widening the skin contact area with the first flexible guard 31 rather than the rigid guard 32. According to an embodiment, the transverse width D3 of the first flexible guard 31 and the transverse width D2 of the rigid guard 32 may be formed to be approximately equal to each other.

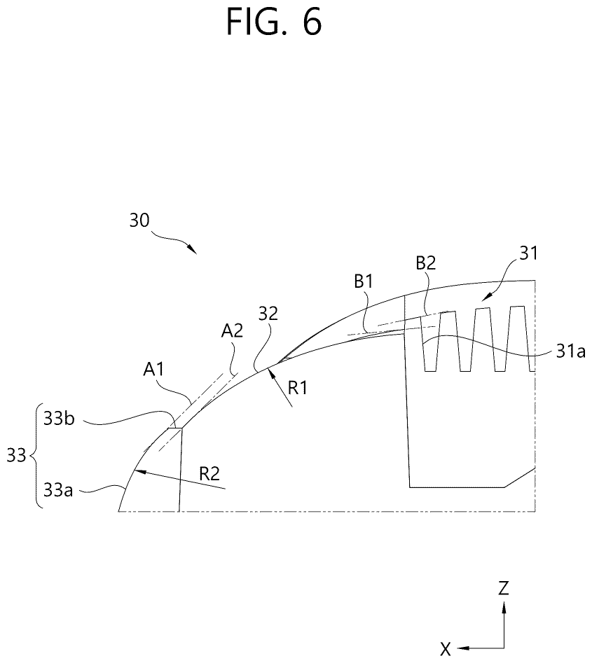

FIG. 6 is an enlarged cross-sectional view of a rigid guard and a second flexible guard of a razor cartridge according to an embodiment of the disclosure.

Referring to FIG. 6, the second flexible guard 33 includes a front portion 33a located in a front surface of the blade housing 20, and an extension portion 33b extending backward from the front portion 33a to form a boundary with the rigid guard 32.

The extension portion 33b may be formed to protrude forward from the rigid guard 32 so that the front portion 33a can form a stepped portion with respect to the rigid guard 32. Accordingly, a tangent line A1 at the rear top surface of the front portion 33a may be located ahead of a tangent line A2 at the front top surface of the rigid guard 32.

An angle of the tangent line A1 at the rear top surface of the front portion 33a to the X-axis may be about 25 to 45 degrees, preferably about 35 to 39 degrees.

An angle of the tangent line A2 at the front top surface of the rigid guard 32 to the X-axis may be about 30 to 55 degrees, preferably about 43 to 48 degrees.

In the boundary between the second flexible guard 33 and the rigid guard 32, the angle of the tangent line A2 at the front top surface of the rigid guard 32 is larger than the angle of the tangent line A1 at the rear top surface of the front portion 33a, thereby enabling the razor cartridge 1 to glide on skin more smoothly.

Meanwhile, the front portion 33a may have a radius R2 of curvature of 1.5 mm to 3 mm, preferably 1.5 mm to 2.5 mm, or more preferably 1.8 mm to 2.6 mm. The rigid guard 32 may have a radius R1 of curvature of 2.0 mm to 5.0 mm, preferably 2.5 mm to 4.5 mm, or more preferably 3.0 mm to 3.5 mm.

Because the front portion 33a of the second flexible guard 33 is formed to have a curved surface rather than a vertical surface, the razor cartridge 1 glides more smoothly, and pulls skin more effectively with the front portion 33a more increased in the contact area with the skin than that of the vertical surface.

Because the radius R1 of the curvature of the rigid guard 32 is formed to be larger than the radius R2 of the curvature of the front portion 33a, smoother gliding of the razor cartridge 1 is possible on the skin.

The second flexible guard 33 comes into contact with a user's skin during the shaving process and is elastically deformed while pressing the skin. Accordingly, when the razor cartridge 1 is not in close contact with the skin, the tangent line A1 at the rear top surface of the front portion 33a is located ahead of the tangent line A2 at the front top surface of the rigid guard 32 as shown in FIG. 6. On the other hand, when the razor cartridge 1 is in close contact with the skin, the tangent line A1 at the rear top surface of the front portion 33a is located closer to the tangent line A2 at the front top surface of the rigid guard 32 than that shown in FIG. 6, and the radius R2 of the curvature of front portion 33a increases while decreasing a difference between the radius R1 of the curvature of the rigid guard 32 and the radius R2 of the curvature of the front portion 33a.

Referring to FIG. 6, an angle of a tangent line B1 at the rear top surface of the rigid guard 32 to the X-axis may be about 2 to 7 degrees, preferably about 3 to 5 degrees.

An angle of a tangent line B2 at the top surface of the front flexible fin 31a to the X-axis may be about 8 to 15 degrees, preferably about 11 to 13 degrees.

In the boundary between the first flexible guard 31 and the rigid guard 32, the angle of the tangent line B2 at the top surface of the front flexible fin 31a is larger than the angle of the tangent line B1 at the rear top surface of the rigid guard 32, smoother gliding of the razor cartridge 1 on the skin is possible.

A person having ordinary knowledge in the art to which the disclosure pertains can understood that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor cartridge comprising:
at least one blade comprising a cutting edge;
a blade housing configured to accommodate the blade in a longitudinal direction; and
a guard portion disposed in front of the blade with respect to a shaving direction, wherein the guard portion comprises:
a first flexible guard disposed adjacent to the blade and configured to contact skin of a user; and
a rigid guard disposed in front of the first flexible guard with respect to the shaving direction, the rigid guard having unevenness having a three-dimensional surface roughness (SA) of 20 μm to 200 μm on a surface thereof.

2. The razor cartridge of claim 1, wherein at least a portion of the surface of the rigid guard comprises a curved profile whose slope with a shaving plane increases forward.

3. The razor cartridge of claim 2, wherein:
the blade housing further comprises a cap portion disposed at the rear of the blade,
the shaving plane comprises a plane where the top of the cap portion and the top of the guard portion are in contact with each other, and
the rigid guard is disposed to have a negative exposure with respect to the shaving plane.

4. The razor cartridge of claim 3, wherein at least a portion of the first flexible guard is disposed to have a negative exposure with respect to the shaving plane.

5. The razor cartridge of claim 3, wherein at least a portion of the first flexible guard is disposed to have a positive exposure with respect to the shaving plane.

6. The razor cartridge of claim 3, wherein the first flexible guard comprises a plurality of flexible fins extending along the longitudinal direction and arranged along a transverse direction perpendicular to the longitudinal direction.

7. The razor cartridge of claim 3, wherein the top surface of the rigid guard is positioned to be lower than the top surface of the first flexible guard.

8. The razor cartridge of claim 7, wherein a height difference is formed near a boundary between the rigid guard and the first flexible guard.

9. The razor cartridge of claim 8, wherein the height difference ranges from 0.1 mm to 1.0 mm.

10. The razor cartridge of claim 2, wherein the surface of the rigid guard has a radius of curvature of 2.0 mm to 5.0 mm.

11. The razor cartridge of claim 2, wherein the rigid guard has a shorter transverse width than the first flexible guard.

12. The razor cartridge of claim 1, wherein the rigid guard retains a shaving aid in a space formed by the unevenness.

13. The razor cartridge of claim 1, wherein the guard portion further comprises a second flexible guard disposed in front of the rigid guard with respect to the shaving direction.

14. The razor cartridge of claim 13, wherein:
the second flexible guard comprises a front portion located in a front surface of the blade housing and having a curved profile, and an extension portion extending from the front portion to form a boundary with the rigid guard, and
the extension portion is formed to protrude forward from the rigid guard so that the front portion can form a stepped portion with respect to the rigid guard.

15. The razor cartridge of claim 14, wherein:
the rigid guard includes a curved profiled to have a larger radius of curvature than the front portion,
the second flexible guard is elastically deformed while coming into contact with skin of a user, and
a difference between the radius of curvature of the front portion and the radius of curvature of the rigid guard is decreased while the second flexible guard is elastically deformed.

16. The razor cartridge of claim 15, wherein the front portion has a radius of curvature of 1.5 mm to 2.5 mm.
